(19) United States
(12) Patent Application Publication
(10) Pub. No.: US 2006/0209032 A1
(43) Pub. Date: Sep. 21, 2006

(54) HANDHELD ELECTRONIC DEVICE

(76) Inventors: Ching-Liang Chiang, Taipei City (TW); Yi-Chen Chung, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,900

(22) Filed: Sep. 27, 2005

(30) Foreign Application Priority Data
Mar. 21, 2005 (TW) 94204333

(51) Int. Cl. G09G 5/00

(52) U.S. Cl. 345/169

(57) ABSTRACT

A handheld electronic device including a main body, a display unit and a press-type keyboard is provided. The main body has a data process module, and the display unit is mounted on the main body. The press-type keyboard having a center and a plurality of keys is mounted on the main body and adjacent to the display unit. Moreover, the closer each key is to the center, the higher the apex of the key is protruding above the main body. Because the height of the keys varies with the distance between the keys and the center, it is more convenient for users when keying in data.

### CROSS-REFERENCE TO RELATED APPLICATION

This application claims the priority benefit of Taiwan application serial no. 94204333, filed on Mar. 21, 2005. All disclosure of the Taiwan application is incorporated herein by reference.

### BACKGROUND OF THE INVENTION

1. Field of Invention

The present invention relates to a handheld electronic device. More particularly, the present invention relates to a handheld electronic device convenient for users to key in data.

2. Description of Related Art

In order to meet the requirement of a light, thin and compact modern electronic device, all kinds of electronic elements have all developed toward a miniature size. As the function of the electronic products is more and more powerful and the volume becomes smaller and smaller, various handheld electronic devices are developing and have gradually replaced the large-scale electronic devices to be the mainstream product in the market. The current popular handheld electronic devices include, for example, a cell phone, a electronic dictionary, a personal digital assistant (PDA), and a palm game device according to different main functions.

The handheld electronic device, for example, a PDA, comprises a main body, a display unit and a press input interface. The main body includes a data processing module, and the display unit is, for example, a liquid crystal display module (LCM). The display unit is usually implemented within the main body, and the display area of the display unit is exposed outside of the main body so as to display the image, pattern and text. Moreover, a plurality of press input interfaces, such as touch screens or keyboards, are mounted on the main body as the controller interface of the handheld electronic device.

The advantage of the handheld electronic device with the touch screen as the press input interface and the keyboard is omitted is that the display area can be almost the same size as the handheld electronic device, but, as the user must use a stylus to key in the data one by one, the input speed is slow. If using the handheld electronic device with a keyboard, the input speed is faster, but the keyboard may occupy substantial space on the surface of the main body of the display unit, so that the size of the display area of the display unit is reduced.

Moreover, a QWERTY-style keyboard, disclosed in U.S. Pat. No. 6,489,950, includes a plurality of tilted and elliptic keys, wherein one half of them are averagely arranged on the left side of the housing of the electric device, while the remaining keys are arranged on the right side of the housing of the electronic device. And, the keys are arranged in three columns, and the keys in each column are arranged on the housing of the electronic device along an arc. The keyboard is convenient for users to control the electronic device by the thumb, but the space among the keys can only be distinguished in a 2-D horizontal plane. Accordingly, the present invention provides another handheld electronic device to help users control the electronic device by hand.

### SUMMARY OF THE INVENTION

Accordingly, the present invention is directed to a handheld electronic device to improve the convenience for users to key in data by hand.

The present invention provides a handheld electronic device, including a main body, a display unit and a press-type keyboard. The main body has a data process module, and the display unit is mounted on the main body. In addition, the press-type keyboard having a center point and a plurality of keys is mounted on the main body and adjacent to the display unit. Moreover, each key has an apex in the thickness direction of the main body, wherein the closer each key is to the center point, the higher the apex of the key is protruding above the main body.

According to one embodiment of the present invention, the apexes of the keys are in a arc plane, and the center of the arc plane is higher than the edge of the arc plane relative to the main body.

According to one embodiment of the present invention, the main body has a center line in the length direction, and the center line passes through the center point of the press-type keyboard. With the center line as the symmetrical axis, the keys are substantially arranged in multiple lines on the two side of the center line on the main body, and the length directions of the keys are substantially parallel to the center line.

According to one embodiment of the present invention, the keys are substantially arranged in more than four columns on the main body along a plurality of arcs substantially parallel to each other, and each of the arcs has an opening towards the display unit.

According to one embodiment of the present invention, the press-type keyboard includes a QWERTY-type keyboard.

According to one embodiment of the present invention, the keys include a plurality of alphabet keys.

According to one embodiment of the present invention, the display unit includes a touch screen display panel.

According to one embodiment of the present invention, the handheld electronic device further includes a function key located between the display unit and the press-type keyboard, and the function key is used for switching the input mode.

The handheld electronic device of the present invention has a configuration that the closer each key is to the center, the higher the apex of the key is protruding above the main body. Therefore, when using the handheld electronic device, users can easily distinguish these keys by the height variations of the key apexes, such increasing the convenience of keying in data by hand.

In order to the make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a front view of a handheld electronic device according to one embodiment of the present invention.

FIG. 2 is a right side view of the handheld electronic device of FIG. 1.

FIG. 3 is a top view of the handheld electronic device of FIG. 1.

### DESCRIPTION OF EMBODIMENTS

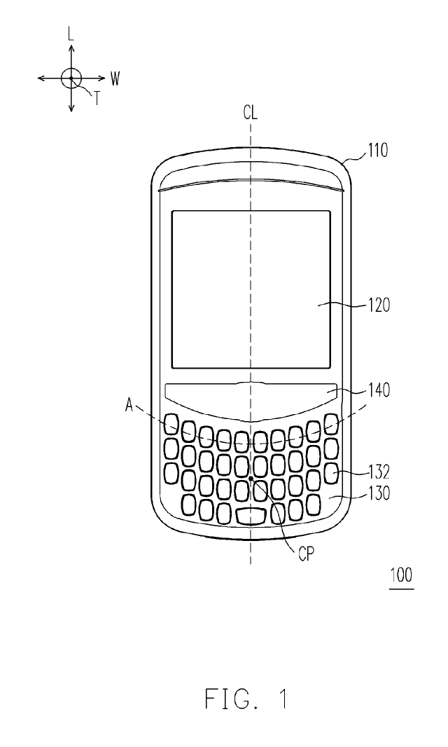

FIGS. 1-3 are a front view, a right side view, and a top view of a handheld electronic device according to one embodiment of the present invention, respectively. Please refer to FIGS. 1-3. The handheld electronic device 100 includes a main body 110, a display unit 120 and a press-type keyboard 130. The main body 110 has a data process module (not shown), and the display unit 120 is mounted on the main body 110. The display unit 120 has a display area exposed outside the surface of the main body 110 to provide the display output of the image, pattern and text. Moreover, the press-type keyboard 130 having a center point CP and a plurality of keys 132 is mounted on the main body 110 and adjacent to the display unit 120. When users key in data in the handheld electronic device 100 by these keys 132 of the press-type keyboard 130, the data process module (not shown) of the handheld electronic device 100 can process the input data, and the display area of the display unit 120 displays the process result.

Note that the each key 132 is closer to the center point CP, the higher the apex of key 132 is protruding above the main body 110. As the heights of the apexes of the keys 132 relative to the center point CP are different, the apexes of the keys 132 approximately form an arc plane (not shown). And, the main body 110 has a center line CL substantially parallel to the length direction L and perpendicular to the width direction W, and the center line CL passes through the center point CP of the press-type keyboard 130. Moreover, with the center line CL as the symmetrical axis, the keys 132 are substantially arranged in multiple lines on the two sides of the center line CL on the main body 110, and the length directions of the keys 132 are, for example, substantially parallel to the center line CL. In addition, the keys 132 are substantially arranged along multiple arcs A substantially parallel to each other and in more than four columns on the main body 110, wherein each of the arc A has an opening towards the display area of the display unit 120.

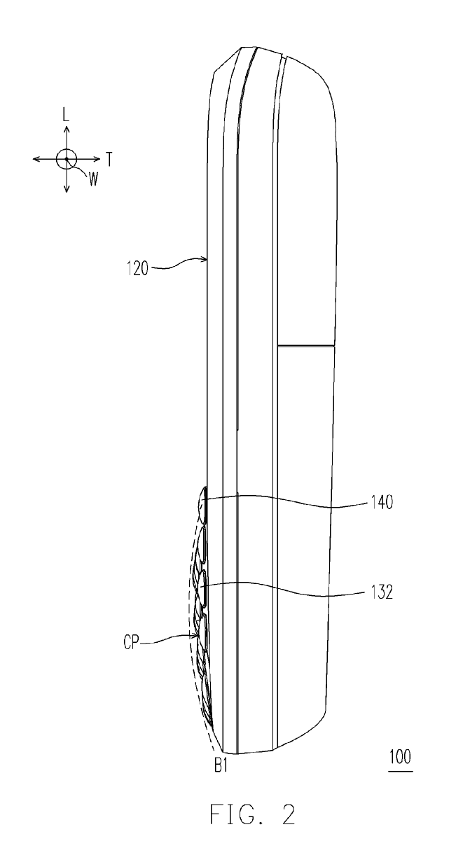

In more detail, the apexes of the keys 132 vary and gradually decline from the center of the arc plane as the center point CP of the press-type keyboard 130 to the edge of the main body 110 relative to the thickness direction T. Therefore, in the right side view of the handheld electronic device 100, i.e., in the length direction L of the handheld electronic device 100 as shown in FIG. 2, the key 132 is closer to the center point CP, the higher the apex of the key 132 is protruding above the main body 110. On the contrary, as the arc B1 shown in FIG. 2, the farther the key 132 is to the center point CP, i.e., the key 132 is closer to the edge of the main body 110, the lower the key 132 is protruding above the main body 110.

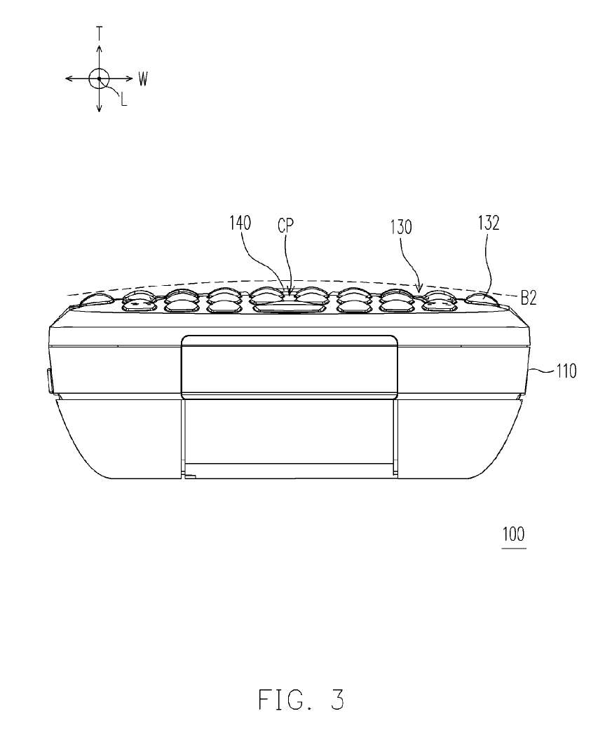

Similarly, in the top view of the handheld electronic device 100, i.e., in the thickness direction T of the handheld electronic device 100 as shown in FIG. 3, the key 132 is closer to the center point CP, the higher the apex of the key 132 is protruding above the main body 110. On the contrary, as the arc B2 shown in FIG. 3, the farther the key 132 is from the center point CP, i.e., the key 132 is closer to the edge of the main body 110, the lower the apex of the key 132 is protruding above the main body 110.

Moreover, the handheld electronic device 100, for example, further includes a function key 140 located between the display unit 120 and the press-type keyboard 130, and the function key 140 is used for switching the input mode. In one embodiment of the present invention, the press-type keyboard 130 is, for example, a QWERTY-style keyboard; the function key 132 is, for example, alphabet keys; and the display unit 120 is, for example, a touch screen display panel.

In summary, the handheld electronic device of the present invention adopts a configuration where each key is closer to the center, the higher the apex of the key is protruding above the main body. That is, the apex of the key at the center of the press-type board is higher while the apex of the keys near the edge of the press-type board is lower. Accordingly, users can easily distinguish the positions of these keys by touching the height variations of these keys by hands or the thumb, which enhances the convenience when keying in data into the handheld electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A handheld electronic device, including:
a main body, having an data process module;
a display unit, mounted on the main body; and
a press-type keyboard, having a center point and a plurality of keys, mounted on the main body and adjacent to the display unit, wherein each key has an apex in the thickness direction of the main body, and each key is closer to the center, the higher the apex of the key is protruding above the main body.

2. The handheld electronic device as claimed in claim 1, wherein the apexes of the keys are in an arc plane, and the center of the arc plane is higher than the edge of the arc plane relative to the main body.

3. The handheld electronic device as claimed in claim 1, wherein the main body has a center line in the length direction, and the center line passes through the center point of the press-type keyboard.

4. The handheld electronic device as claimed in claim 3, wherein, with the center line as the symmetrical axis, the keys are substantially arranged in multiple lines in the two sides of the center line on the main body, and the length directions of the keys are substantially parallel to the center line.

5. The handheld electronic device as claimed in claim 1, wherein the keys are substantially arranged in more than four columns on the main body and along a plurality of arcs substantially parallel to each other, and each of the arcs has an opening towards the display unit.

6. The handheld electronic device as claimed in claim 1, wherein the press-type keyboard includes a QWERTY-type keyboard.

7. The handheld electronic device as claimed in claim 1, wherein the keys include a plurality of alphabet keys.

8. The handheld electronic device as claimed in claim 1, wherein the display unit includes a touch screen display panel.

9. The handheld electronic device as claimed in claim 1, further comprising a function key located between the display unit and the press-type keyboard.

10. The handheld electronic device as claimed in claim 9, wherein the function key is used for switching the input mode.
